(19) United States
(12) Patent Application Publication
(10) Pub. No.: US 2013/0120271 A1
(43) Pub. Date: May 16, 2013

(54) DATA INPUT METHOD AND APPARATUS FOR MOBILE TERMINAL HAVING TOUCHSCREEN

(71) Applicant: SAMSUNG ELECTRONICS CO., LTD., Gyeonggi-do (KR)

(72) Inventors: Joohyung Lee, Gyeonggi-do (KR); Seokhee Na, Incheon (KR); Ying Dong, Seoul (KR); Junghwa Shim, Seoul (KR)

(73) Assignee: SAMSUNG ELECTRONICS CO., LTD., Gyeonggi-do (KR)

(21) Appl. No.: 13/671,747

(22) Filed: Nov. 8, 2012

(30) Foreign Application Priority Data
Nov. 11, 2011 (KR) 10-2011-0117428

(51) Int. Cl. G06F 3/041; G06F 3/02

(52) U.S. Cl. 345/168

(57) ABSTRACT

A data input method and apparatus for a mobile terminal having a touchscreen includes: sensing a touch gesture of a user on the touchscreen; checking whether the sensed touch gesture is a split keypad request; and displaying, when the sensed touch gesture is a split keypad request, at least two split keypads in a display area of the touchscreen, and displaying a function execution screen in an unused region (dead space) between the split keypads.

### CLAIM OF PRIORITY

This application claims the benefit under 35 U.S.C. §119(a) of a Korean patent application filed on Nov. 11, 2011 in the Korean Intellectual Property Office and assigned Serial No. 10-2011-0117428, the entire disclosure of which is hereby incorporated by reference.

### BACKGROUND OF THE INVENTION

1. Field of the Invention

The present invention relates to an apparatus and a data input method in a mobile terminal having a touchscreen and, more particularly, to a data input method and apparatus that enable a data entry using at least two split keypads displayed on the touchscreen.

2. Description of the Related Art

Rapid advances in communication and semiconductor technologies have led to enormous popularization of various types of mobile terminals. High-end mobile terminals have evolved into mobile convergence devices supporting multiple functions from various applications and fields. In particular, mobile terminals are increasingly equipped with touchscreens, which enable user actions on the touchscreen to control an application on the basis of the generated touch events.

A mobile terminal may provide various types of keypads, such as an English QWERTY keypad, English 3*4 keypad, Korean 3*4 keypad and special keypads, through the touchscreen. The user may enter data while transitioning between these keypads during operation. Recently, mobile terminals increasingly support split keypads where a user grips a mobile terminal with both hands to enter data using two thumbs through the split keypads displayed on the touchscreen. Here, from the viewpoint of the user, one split keypad is a left keypad located at a left hand side of the screen and another split keypad is a right keypad located at a right hand side thereof.

However, existing data input methods supporting split keypads may be unable to utilize a region between the left keypad and right keypad on the screen, thus resulting in dead space. The user may also feel uneasy about the unusable space. Hence, it is desirable to develop ways to enable the user to make a good use of the unused space between the left keypad and right keypad on the touchscreen.

### SUMMARY OF THE INVENTION

The present invention has been made in view of the above problems and the present invention provides a data input method and apparatus for a mobile terminal having a touchscreen, wherein the user can enter data by utilizing an unused region of the display area that is not occupied by split keypads displayed on the touchscreen.

In accordance with an exemplary embodiment of the present invention, a data input method for a mobile terminal having a touchscreen includes: sensing a touch gesture of a user on the touchscreen; determining whether the sensed touch gesture is a split keypad request; and displaying, when the sensed touch gesture is a split keypad request, a function execution screen in an unused region (dead space) of the display area that is not occupied by the split keypads.

In accordance with another exemplary embodiment of the present invention, a data input apparatus for a mobile terminal includes: a touchscreen generating a touch event corresponding to a touch gesture of a user; a control unit sensing a touch gesture on the basis of a touch event from the touchscreen, and checking whether the sensed touch gesture is a split keypad request; and a display unit displaying, a function execution screen in an unused region (dead space) of the display area that is not occupied by the split keypads under control of the control unit.

### BRIEF DESCRIPTION OF THE DRAWINGS

The features and advantages of the present invention will be more apparent from the following detailed description in conjunction with the accompanying drawings, in which:

FIG. 1 is a block diagram of a mobile terminal according to an embodiment of the present invention;

FIG. 2 is a flowchart of a data input method according to an embodiment of the present invention;

FIG. 3 is screen representations for displaying split keypads;

FIG. 4 is screen representations for displaying a function execution screen;

FIG. 5 illustrates various function execution screens; and

FIG. 6 is a screen representation illustrating split keypads.

### DETAILED DESCRIPTION OF EXEMPLARY EMBODIMENTS

Hereinafter, a data input method and apparatus are described in detail as exemplary embodiments of the present invention with reference to the accompanying drawings. The meaning of specific terms or words used in the specification and the claims should not be limited to the literal or commonly employed sense, but should be construed in accordance with the spirit of the invention. Further, the description of the various embodiments is to be construed as exemplary only and does not describe every possible instance of the invention. Therefore, it should be understood that various changes may be made and equivalents may be substituted for elements of the invention. In the drawings, some elements are exaggerated or only outlined in brief, and thus may be not drawn to scale. Thus, the present invention is not limited by relative sizes of objects and intervals between objects in the drawings.

It should be noted that the data input method and apparatus of the present invention may be applied to various types of mobile terminals, in particular, mobile terminals having a touchscreen as an input unit and supporting split keypads. Further, the mobile terminal may be one of a cellular phone, smartphone, tablet computer, hand-held computer, personal digital assistant (PDA), music player like an MP3 player, portable game console, and digital broadcast receiver.

Briefly, according to the teachings of the present invention, the data input method and apparatus provide a function related screen at dead space (unused region) formed between split keypads. On the touchscreen, “dead space” refers to an unused region of the display area that is not occupied by split keypads. Here, a function related screen may refer to a screen or window used to execute or control a user function of the mobile terminal. For example, a function related screen may be a small keypad or an application screen. Hence, the user may use a separate keypad displayed in the unused region to enter data, which is not enterable through the split keypads, without changing input modes of the split keypads. In addition, the user may use an application screen displayed in the unused region to enter data that is to be used to control the corresponding application such as a messenger program or social networking service (SNS) program.

Hereinafter, a description is given of features of the present invention. However, detailed descriptions of well-known functions and structures incorporated herein may be omitted to avoid obscuring the subject matter of the present invention.

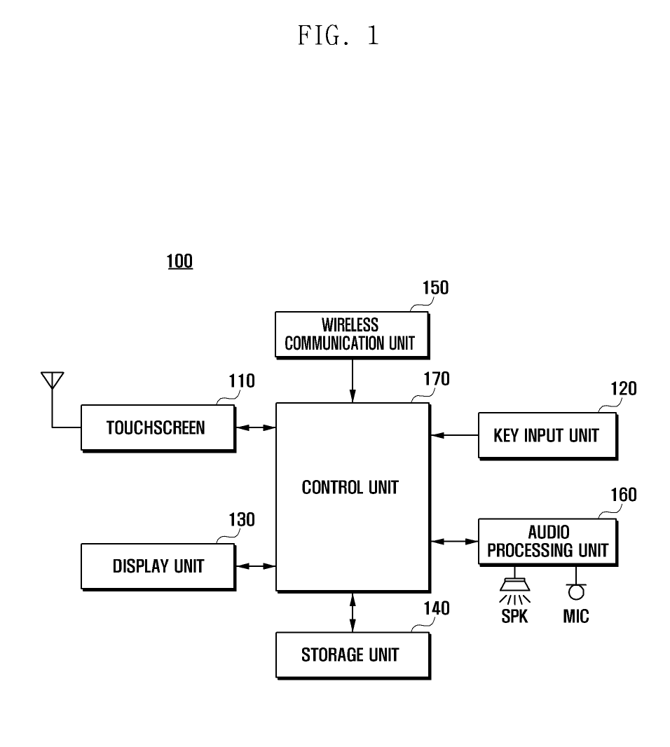

FIG. 1 is a block diagram of a mobile terminal 100 according to an embodiment of the present invention. As shown, the mobile terminal 100 may include a touchscreen 110, a key input unit 120, a display unit 130, a storage unit 140, a wireless communication unit 150, an audio processing unit 160 including a speaker SPK and a microphone MIC, and a control unit 170.

The touchscreen 110 placed on the display unit 130 generates a touch event corresponding to a touch contact, motion or gesture made by the user on the touchscreen 110 and sends the touch event to the control unit 170. The control unit 170 may control other components on the basis of a touch event sent by the touchscreen 110. Here, touch gestures may include touch, tap, double tap, press, drag, drag and drop, and sweep. A touch corresponds to a single point contact with the screen; a tap corresponds to touch and release at the same point; a double tap corresponds to two consecutive taps at the same point; a press corresponds to long touch and release at the same point; a drag corresponds to touch and move in one direction; a drag and drop corresponds to drag and release; and a sweep corresponds to touch and fast move. Drag and sweep are referred to as scroll and flick, respectively. The control unit 170 may distinguish sweep from drag by movement speed. The touchscreen 110 may be realized using resistive type, capacitive type, electromagnetic induction type or pressure type technology.

The key input unit 120 includes a plurality of alphanumeric and function keys for inputting alphanumeric information and for setting various functions. The function keys may include direction, side, and shortcut keys associated with corresponding functions. The key input unit 120 transmits key signals from the user for setting and controlling the mobile terminal 100 to the control unit 170. Key signals may be related to power on/off, volume control, and screen on/off. The control unit 170 may control the components according to key signals. The key input unit 120 may include a QWERTY keypad, a 3*4 keypad, or a 4*3 keypad, including multiple keys. When the mobile terminal 100 is a full touchscreen type device, the key input unit 120 may include only one or more side keys that are arranged at sides of the case of the mobile terminal 100 for screen on/off and power on/off.

The display unit 130 converts image data from the control unit 170 into an analog signal and displays the analog signal under control of the control unit 170. The display unit 130 may output various screens generated in the course of using the mobile terminal 100, such as a lock screen, home screen, application screen, menu and keypad. The lock screen is displayed when the display unit 130 is turned on. When a given touch event for unlocking is generated, the control unit 170 may transition from the lock screen to the home screen or a preset application screen. The home screen includes a plurality of icons mapped to various applications. When one of the icons is selected by the user, the control unit 170 may execute an application mapped with the selected icon and control the display unit 130 to display the corresponding application screen. The menu may include a key for screen transition (for example, a “back” key for returning to the previous screen), and a key for controlling an application being executed.

In particular, the display unit 130 displays split keypads under control of the control unit 170. The display unit 130 may display a function selection screen in the unused region between the split keypads. When a function is selected from the function selection screen, the display unit 130 may display a corresponding function related screen. The function related screen may be an application screen or a keypad. Under control of the control unit 170, the display unit 130 may simultaneously display different screens. For example, the display unit 130 may output both a keypad and an application screen at two different regions of the display area. Further, under control of the control unit 170, the display unit 130 may display a main screen and a sub screen so that the sub screen is overlapped with the main screen. For example, the display unit 130 may display the home screen, and display split keypads and a function related screen on the home screen so that the function related screen is overlapped with the split keypads. Meanwhile, the display unit 130 may be realized using a flat display panel composed of liquid crystal display (LCD) devices, organic light emitting diodes (OLED), or active matrix organic light emitting diodes (AMOLED).

The storage unit 140 may store an operating system (OS) of the mobile terminal 100, applications related to the present invention, and various data. The storage unit 140 may include a program section and a data section.

The data section of the storage unit 140 may store data generated in the course of using the mobile terminal 100 or downloaded from the outside, such as contacts, images, documents, moving images, text messages, email messages and music files. The data section may store screens to be output to the display unit 130. The data section may store various virtual keypads. These keypads may be classified into QWERTY keypads, 3*4 keypads and split keypads according to the arrangement and number of keys. The keypads may be classified into numeric keypads, English keypads, Hangul keypads and symbol keypads according to data input mode. The data section may store, as members of the keypad category, clipboards for entering data (such as images, icons and characters) through copy and paste, emoticons, templates for entering idiomatic phrases (such as “Hello!”, “Please wait a moment” and “Please leave contact information”), and edit panels for editing input data. Here, an edit panel may include keys for delete, cut, copy, paste and move. Emoticons refer to a symbol, character or image indicating feelings and intentions of the user. The data section may temporarily store data extracted from a message, photograph, webpage, or document for paste. The data section may store various setting option values (for example, screen brightness, vibration upon touch, and automatic screen rotation) for operation of the mobile terminal 100.

The program section of the storage unit 140 may store an operating system for booting the mobile terminal 100 and operating individual components thereof, and various applications. For example, the program section may store a web browser for accessing the Internet, MP3 player for music playback, camera application, SNS application, messenger, and e-book reader. Here, the messenger is a program for sending and receiving data through the wireless communication unit 150. The SNS application is a program that enables the user to form personal connections on the Internet by means of a social networking service like Facebook or Twitter. The program section may store a handwriting recognition application that analyzes handwriting of the user and displaying corresponding candidate words retrieved from a database. In this case, the program section may further store a database containing candidate words for handwriting recognition. In particular, the program section may store a dead space utilization program that enables the user to utilize an unused region formed between split keypads (dead space) on the screen to execute a desired function of the mobile terminal 100. The dead space utilization program may include a routine for displaying split keypads, a routine for display a function selection screen in the dead space, and a routine for displaying a screen of the selected function in the dead space.

The wireless communication unit 150 performs communication operations for voice call, video calls and data calls under control of the control unit 170. To achieve this, the wireless communication unit 150 may include a radio frequency transmitter for upconverting the frequency of a signal to be transmitted and amplifying the signal, and a radio frequency receiver for low-noise amplifying a received signal and downconverting the frequency of the received signal. The wireless communication unit 150 may include a mobile communication module (based on 3G, 3.5G or 4G mobile communication), a local area communication module (such as a Wi-Fi module), and a digital broadcast receiving module (such as a DMB module).

The audio processing unit 160 sends an audio signal from the control unit 170 to the speaker SPK, and sends an audio signal like a voice signal input from the microphone MIC to the control unit 170. That is, the audio processing unit 160 may output voice or sound data as audible sound through the speaker SPK, and convert an audio signal like a voice signal input from the microphone MIC into a digital signal and send the digital signal to the control unit 170.

The control unit 170 may control the overall operation of the mobile terminal 100, control signal exchanges between internal components thereof, and perform data processing. The control unit 170 may control a power supply from a battery to the internal components. The control unit 170 may execute various applications stored in the program section. In particular, the control unit 170 may execute the dead space utilization program to display a function related screen in dead space between split keypads. Operations of the control unit 170 are described in detail later with reference to the drawings.

Although not shown in FIG.1, the mobile terminal 100 may further include a camera module, a GPS receiving module, a sensor module for sensing state and orientation changes, and an interface module for connecting with an external device through a wired or wireless connection. With the digital convergence trend, it should be apparent to those skilled in the art that the mobile terminal 100 may further include a unit comparable to the above-described units, and one unit thereof may be removed or replaced with another unit.

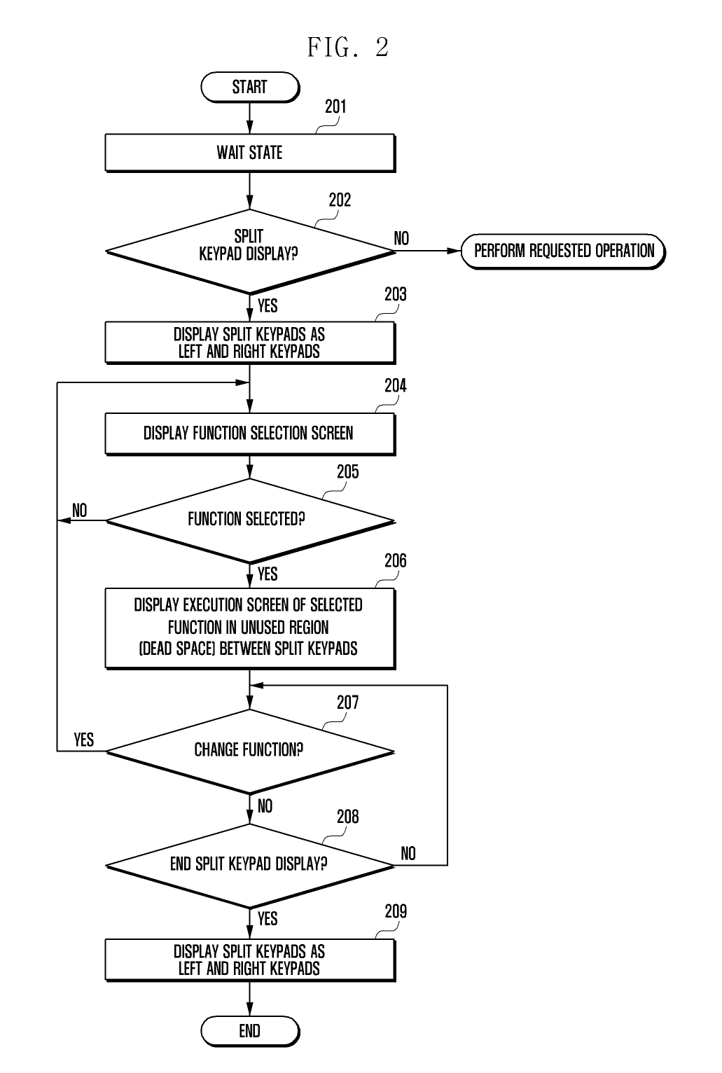

FIG. 2 is a flowchart of a data input method according to an embodiment of the present invention.

Referring to FIG. 2, during a wait state (201) or an idle state, the display unit 130 may display various screens other than split keypads in the wait state. When the user manipulates the touchscreen 110 in the wait state, the touchscreen 110 generates a corresponding touch event and sends the touch event to the control unit 170, which senses a touch gesture of the user on the basis of the touch event.

The control unit 170 checks whether the sensed touch gesture is a request for split keypads (202). If not, the control unit 170 performs an operation corresponding to the sensed touch gesture. For example, if the sensed touch gesture is related to an SNS application, the control unit 170 may executes the SNS application and control the display unit 130 to display a corresponding application screen.

When the sensed touch gesture is a request for split keypads, the control unit 170 controls the display unit 130 to display split keypads as left and right keypads (203). The control unit 170 controls the display unit 130 to display a function selection screen in the dead space between the split keypads (204). Here, the function selection screen includes menu items associated with functions of the mobile terminal 100. For example, the menu items may be associated with a numeric keypad, symbol keypad, edit panel, clipboard, emoticon, messenger program, web browser and handwriting recognition program.

When the user manipulates the touchscreen 110 while the function selection screen is displayed, the touchscreen 110 generates a corresponding touch event and sends the touch event to the control unit 170, which senses a touch gesture of the user on the basis of the touch event. The control unit 170 checks whether the sensed touch gesture is an indication for function selection from the function selection screen (205). If not, the control unit 170 may perform an operation corresponding to the sensed touch gesture and return to step 204. For example, when the sensed touch gesture is related with data entry through the split keypads, the control unit 170 may control the display unit 130 to display data input though the split keypads and return to step 204, continuing display of the function selection screen in the dead space.

When the sensed touch gesture is an indication for function selection, the control unit 170 executes the selected function and controls the display unit 130 to display an execution screen for the selected function in the dead space (206). Here, the display unit 130 may display a function change icon together with the function execution screen.

When the user manipulates the touchscreen 110 while the function execution screen is displayed, the control unit 170 senses a touch gesture detected on the touch screen 110. The control unit 170 checks whether the sensed touch gesture is a request for function change (207). If so, the control unit 170 returns to step 204, and if not, the control unit 170 checks whether the sensed touch gesture is a termination request for split keypads (208). When the sensed touch gesture is not a termination request for split keypads, the control unit 170 may perform an operation corresponding to the sensed touch gesture and return to step 207. For example, when the sensed touch gesture is related with data entry through the split keypads, the control unit 170 may control the display unit 130 to display data input though the split keypads and return to step 207. When the sensed touch gesture is a termination request for split keypads, the control unit 170 ends display of the split keypads and the function execution screen (209).

Next, a more detailed description is given of the data input method and apparatus with reference to multiple screen representations.

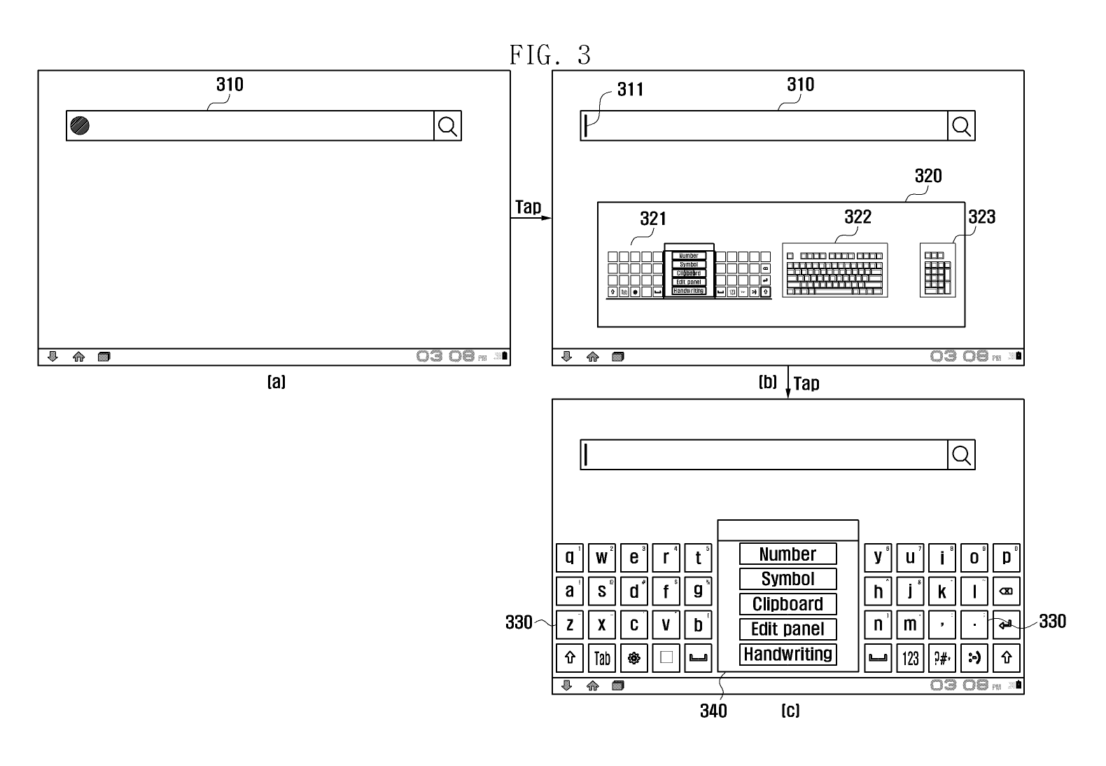

FIG. 3 is screen representations for displaying split keypads. Referring to FIG. FIG. 3(a), the display unit 130 displays a data input field 310 under control of the control unit 170. When the user enters a tap on the data input field 310, the control unit 170 controls the display unit 130 to display the cursor 311 within the data input field 310 and to display a keypad selection menu 320 as shown in FIG. 3(b). Here, the keypad selection menu 320 includes a split keypad icon 321, a qwerty keypad icon 322 and a 3*4 keypad icon 323. When the split keypad icon 321 is tapped from the keypad selection menu 320, the control unit 170 controls the display unit 130 to display split keypads 330 and a function selection screen 340 as shown in FIG. 3(c). In the case where the data input field 310 is tapped as shown in FIG. 3(b), the control unit 170 may control the display unit 130 to directly display the split keypads 330 without display of the keypad selection menu 320. Alternatively, when the data input field 310 or the split keypad icon 321 is tapped, the control unit 170 may control the display unit 130 to directly display a preset function execution screen without display of the function selection screen 340.

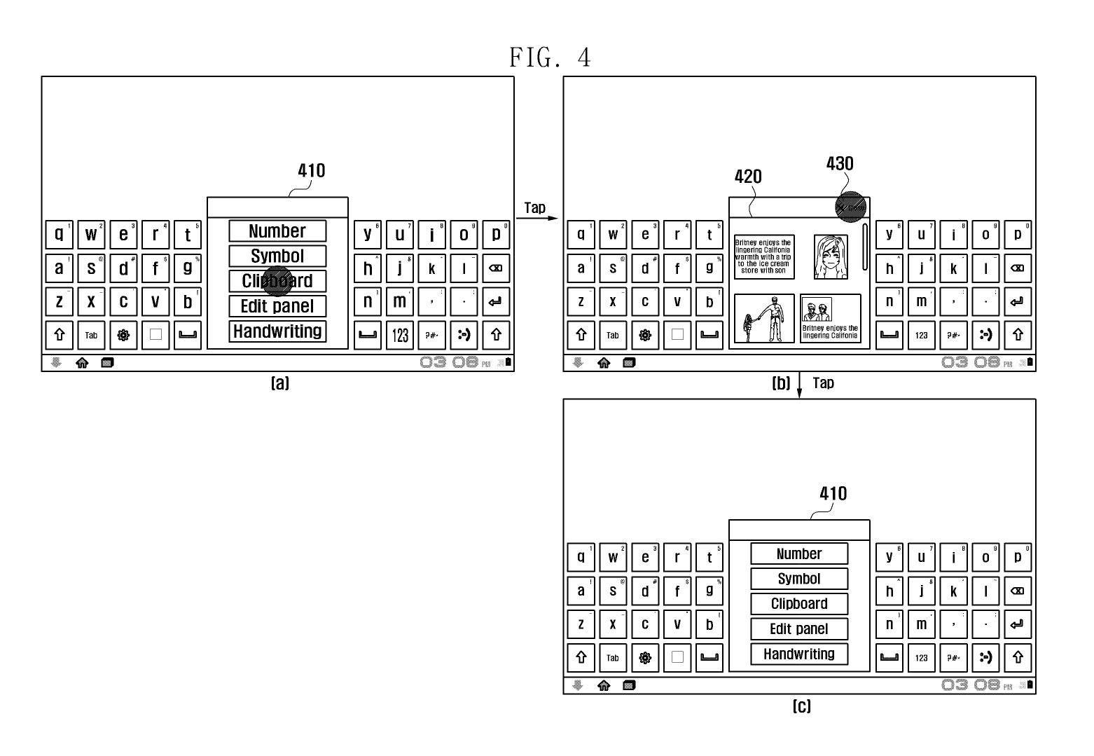

FIG. 4 is screen representations for displaying a function execution screen. Referring to FIG. 4(a), the display unit 130 displays a function selection screen 410 in the dead space between split keypads under control of the control unit 170. Here, the function selection screen 410 includes items for a number keypad, symbol keypad, clipboard, edit panel, and handwriting recognition application. When the clipboard item is tapped by the user, the control unit 170 controls the display unit 130 to display a clipboard screen 420 in the dead space between the split keypads as shown by (b) of FIG. 4. Here, the function selection screen 410 is replaced with the clipboard screen 420. The display unit 130 displays a function change icon 430 together with the clipboard screen 420 under control of the control unit 170. When the function change icon 430 is tapped while the clipboard screen 420 is displayed, the control unit 170 controls the display unit 130 to redisplay the function selection screen 410 in the dead space between the split keypads as shown by (c) of FIG. 4. Here, the clipboard screen 420 is replaced with the function selection screen 410.

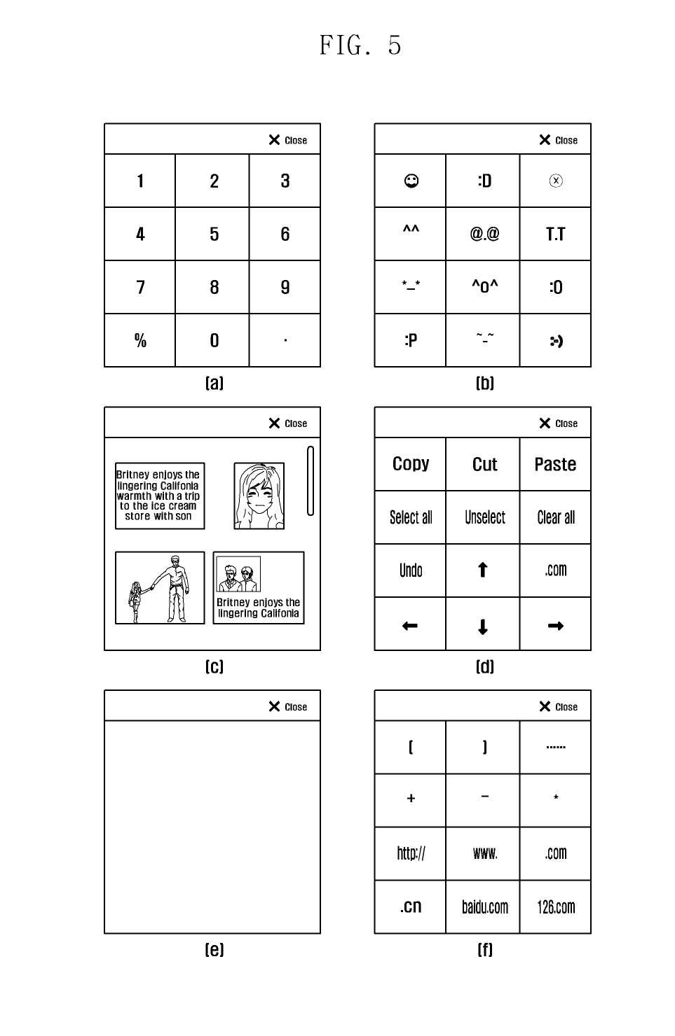

FIG. 5 illustrates various function execution screens according to the teachings of the present invention for illustrative purposes, thus it should be noted that other combination of execution screens can be implemented. In FIG. 5, (a) illustrates a number keypad; (b) illustrates a symbol keypad; (c) illustrates a clipboard screen; (d) illustrates an edit panel; (e) illustrates a handwriting recognition screen; and (f) illustrates another symbol keypad. Each of the function execution screens illustrated above may be displayed in the dead space between split keypads. In an alternate embodiment, other function execution screens may also be displayed in the dead space between split keypads.

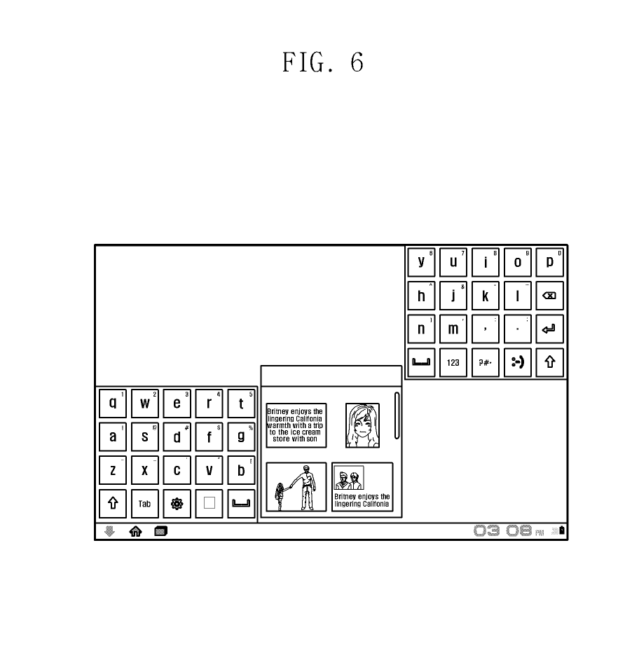

FIG. 6 is a screen representation illustrating split keypads according to another embodiment of the invention. In FIG. 6, the split keypads are left and right keypads. Unlike FIG. 4, the right keypad is placed at an upper right portion of the display area. The split keypads shown in FIG. 4 may correspond to a case in which the lower part of the mobile terminal 100 is gripped by the left and right hands. Alternatively, the split keypads shown in FIG. 6 may correspond to a case in which the lower left part of the mobile terminal 100 is gripped by the left hand and the upper right part thereof is gripped by the right hand. Although not shown, the arrangement in FIG. 6 can be reversed. Accordingly, the split keypads according to the teachings of the present invention may be displayed at different locations or orientation according to usage conditions, i.e., grip patterns of the user.

According to the present invention, the data input method and apparatus enable an efficient utilization of an unused region that is not occupied by split keypads on the touchscreen in order to enhance user's experience. That is, the user may use a separate keypad displayed in the unused region to enter data, which is not enterable through the split keypads, without changing existing input modes of the split keypads. In addition, the user may use an application screen displayed in the unused region to enter data that is to be used to control the corresponding application.

It should be note that the left keypad and right keypad are to be construed as exemplary only, and the present invention is not limited thereby. In the specification, “split keypads” refer to two or more smaller keypads that can be combined into a larger keypad. In other words, a virtual keypad on the touchscreen may be divided into two or more split keypads. Further, the number and location of split keypads may be varied according to usage conditions of the mobile terminal. For example, display locations of split keypads may be varied according to orientation of the mobile terminal and user's grip thereon with both hands.

Further, the above-described methods according to the present invention can be implemented in hardware, firmware or as software or computer code that can be stored in a recording medium such as a CD ROM, an RAM, a floppy disk, a hard disk, or a magneto-optical disk or computer code downloaded over a network originally stored on a remote recording medium or a non-transitory machine readable medium and to be stored on a local recording medium, so that the methods described herein can be rendered in such software that is stored on the recording medium using a general purpose computer, or a special processor or in programmable or dedicated hardware, such as an ASIC or FPGA. As would be understood in the art, the computer, the processor, microprocessor controller or the programmable hardware include memory components, e.g., RAM, ROM, Flash, etc. that may store or receive software or computer code that when accessed and executed by the computer, processor or hardware implement the processing methods described herein. In addition, it would be recognized that when a general purpose computer accesses code for implementing the processing shown herein, the execution of the code transforms the general purpose computer into a special purpose computer for executing the processing shown herein.

Although embodiments of the present invention have been described in detail hereinabove, it should be understood that many variations and modifications of the basic inventive concept described herein will still fall within the spirit and scope of the present invention as defined in the appended claims.

What is claimed is:

1. A method for data input in a mobile terminal having a touchscreen, comprising:
sensing a touch gesture on the touchscreen;
determining whether the sensed touch gesture is a split keypad request; and
displaying, when the sensed touch gesture is a split keypad request, a function execution screen in an unused region of a display area between a least two split keypads.

2. The method of claim 1, wherein displaying the function execution screen comprises:
displaying one split keypad as a left keypad located at a left side of the touchscreen and displaying another split keypad as a right keypad located at a right side of the touchscreen; and
displaying the function execution screen in the unused region between the left keypad and the right keypad.

3. The method of claim 1, wherein displaying the function execution screen comprises:
displaying the function selection screen including menu items associated with functions of the mobile terminal in the unused region; and
displaying, when a contact selecting one of the menu items sensed, an execution screen of a function associated with the selected menu item in the unused region.

4. The method of claim 3, wherein displaying the function execution screen further comprises:
displaying a function change icon in the unused region; and
displaying, when a contact selecting the function change icon is sensed, the function selection screen again in the unused region instead of the execution screen.

5. The method of claim 1, wherein the function execution screen is one of a keypad and an application execution screen.

6. The method of claim 5, wherein the keypad displayed in the unused region is one of a number keypad, symbol keypad, clipboard, emoticon, template and edit panel.

7. The method of claim 5, wherein the application execution screen displayed in the unused region is an execution screen of one of a handwriting recognition application type, a web browser application type, a messenger application type, and a social networking service (SNS) application type.

8. The method of claim 1, wherein determining whether the sensed touch gesture is a split keypad request comprises:
displaying, when the sensed touch gesture is a touch on a data input field, a keypad selection menu including a split keypad icon; and
sensing a contact on the split keypad icon of the keypad selection menu.

9. An apparatus for data input in a mobile terminal, comprising:
a touchscreen generating a touch event;
a control unit sensing a touch gesture corresponding to the touch event from the touchscreen, and checking whether the sensed touch gesture is a split keypad request; and
a display unit displaying a function execution screen in an unused region of the display area between a least two split keypads under control of the control unit.

10. The apparatus of claim 9, wherein the display unit displays one split keypad as a left keypad located at a left side of the touchscreen, displays another split keypad as a right keypad located at a right side of the touchscreen, and displays the function execution screen in the unused region between the left keypad and the right keypad.

11. The apparatus of claim 9, wherein the control unit controls, when a sensed touch gesture is a split keypad request, an operation to display a function selection screen including menu items associated with functions of the mobile terminal in the unused region, and controls, when a touch gesture selecting one menu item is sensed, an operation to display an execution screen of a function associated with the selected menu item in the unused region.

12. The apparatus of claim 11, wherein the control unit controls an operation to display a function change icon in the unused region together with the execution screen, and controls, when a touch gesture selecting the function change icon is sensed, an operation to display the function selection screen again in the unused region instead of the execution screen.

13. The apparatus of claim 9, wherein the function execution screen is one of a keypad and an application execution screen.

14. The apparatus of claim 13, wherein the keypad displayed in the unused region is one of a number keypad, symbol keypad, clipboard, emoticon, template, and edit panel.

15. The apparatus of claim 13, wherein the application execution screen displayed in the unused region is an execution screen of one of a handwriting recognition application type, a web browser type, a messenger application type, and a social networking service (SNS) application type.

16. The apparatus of claim 9, wherein the control unit controls, when a sensed touch gesture is a touch on a data input field, an operation to display a keypad selection menu including a split keypad icon, and controls, when a sensed touch gesture is a touch on the split keypad icon of the keypad selection menu, an operation to display the split keypads and the function execution screen.
